(19) United States
(12) Patent Application Publication
(10) Pub. No.: US 2022/0112003 A1
(43) Pub. Date: Apr. 14, 2022

(54) DISPENSERS FOR GUIDING CONTENTS OF A CONTAINER

(71) Applicants: Dionne Sanders, Riverview, FL (US); William Tapia, Weston, FL (US)

(72) Inventors: Dionne Sanders, Riverview, FL (US); William Tapia, Weston, FL (US)

(21) Appl. No.: 17/450,438

(22) Filed: Oct. 8, 2021

Related U.S. Application Data
(60) Provisional application No. 63/089,715, filed on Oct. 9, 2020.

(51) Int. Cl. B65D 35/46; B05B 1/16

(52) U.S. Cl. CPC B65D 35/46; B05B 11/3042; B05B 1/16

(57) ABSTRACT

Several configurations of dispenser attachments are disclosed herein. In some embodiments, the dispenser attachment comprises an inlet configured to couple with a container, and at least a first outlet and a second outlet, wherein the first outlet and the second outlet are in fluid communication with the inlet. The dispenser attachment further includes at least a first cap and a second cap, wherein the first cap is configured to removably couple with the first outlet and the second cap is configured to removably couple with the second outlet. The dispenser attachment may be integrally formed with the container and may allow for several users to share a common container while reducing likelihood of germ transfer between the users via the common container.

### CROSS REFERENCE TO RELATED APPLICATIONS

The present application claims the benefit of U.S. Provisional Patent Application No. 63/089,715 filed Oct. 9, 2020 and entitled “Dispensers for Guiding Contents of a Container.”

### FIELD

The present disclosure relates to packaging components that may be used to dispense a substance contained therein in a way that reduces transmission of germs between people sharing a common product.

### SUMMARY

A dispenser attachment in accordance with embodiments disclosed herein comprises a dispenser inlet configured to couple with a container, and at least two outlets. Each of the at least two outlets may include a removable cover. The dispenser attachment may be removably coupled with the container, permanently coupled with the container, and/or integrally formed with the container. The dispenser attachment may further include various color, pattern, shape, or texture schemes to distinguish a first of the at least two outlets from at least a second of the at least two outlets. Various other aspects and advantages of dispenser attachment embodiments will be apparent from the following description and figures.

### BRIEF DESCRIPTION OF THE DRAWINGS

FIGS. 1A and 1B illustrate side views of example packaging.

FIGS. 2A and 2B illustrate side views of example packaging.

FIGS. 3A, 3B, and 3C show a perspective, side, and top view, respectively, of a dispenser attachment in accordance with some embodiments.

FIGS. 4A and 4B show a front and a top view, respectively, of a dispenser attachment in accordance with some embodiments.

FIGS. 4C-4G show side views of a dispenser attachment in accordance with some embodiments.

FIGS. 5A and 5B show a top cross-sectional and a side cross-sectional view, respectively, of a dispenser attachment in accordance with some embodiments.

FIGS. 6A and 6B illustrate a front and a top view, respectively, of a dispenser attachment in accordance with some embodiments.

FIGS. 6C and 6D show a top cross-sectional and a side cross-sectional view, respectively, of a dispenser attachment in accordance with some embodiments.

FIGS. 7A and 7B show a front and a top cross-sectional view, respectively, of a dispenser attachment in accordance with some embodiments.

FIGS. 8A, 8B, and 8C show a side, bottom, and perspective view, respectively, of a cap in accordance with some embodiments.

FIGS. 9A and 9B show a side view of an example packaging including a cap, in accordance with some embodiments.

FIGS. 10A and 10B show a side view of an example packaging including a cap, in accordance with some embodiments.

FIGS. 11A and 11B show side views of an assembled and a disassembled example packaging, in accordance with some embodiments.

FIGS. 12A and 12B show side views of an assembled and a disassembled example packaging, in accordance with some embodiments.

FIGS. 13A and 13B show front and side views, respectively, of a dispenser attachment in accordance with some embodiments.

FIGS. 14A and 14B show dimensioned front and side views, respectively, of a dispenser attachment in accordance with some embodiments.

FIGS. 15A and 15B show perspective views of a dispenser attachment having caps removed and caps attached, respectively, in accordance with some embodiments.

FIG. 15C shows a perspective view of a dispenser attachment with caps attached, in accordance with some embodiments.

FIG. 15D illustrates a detailed view of dispenser attachment nozzle geometry underneath an attached cap, in accordance with some embodiments.

FIGS. 15E and 15F illustrate bottom and top perspective views, respectively, of a dispenser attachment, in accordance with some embodiments.

### DETAILED DESCRIPTION

Articles, systems, and methods are described herein with reference to the accompanying drawings. Such articles, systems, and methods embody particular configurations of the claimed invention; however, additional and/or alternative embodiments are possible and the illustrated and described embodiments should not be construed as limiting. Rather, these embodiments are provided so that this disclosure will be thorough and complete, and will convey the scope of the inventive concepts to those skilled in the art. In the drawings, the size and relative sizes of layers and regions may be exaggerated for clarity. Like numbers refer to like elements throughout.

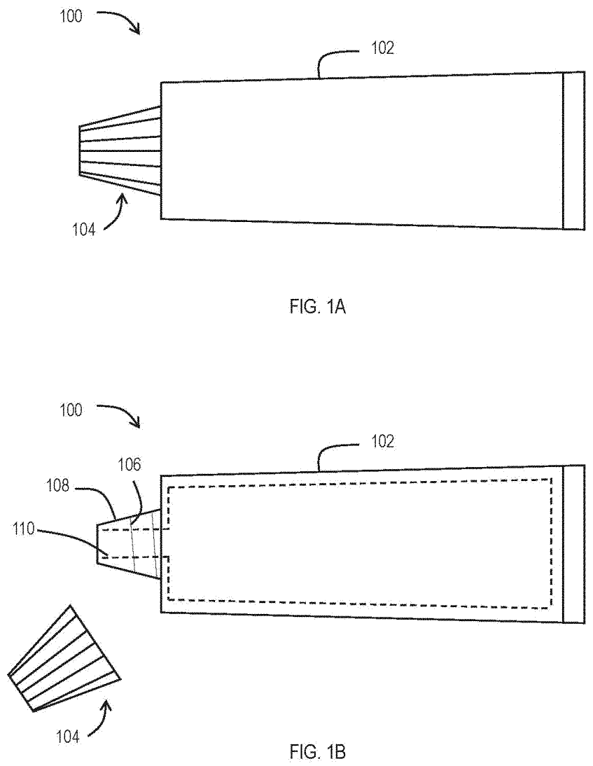

FIGS. 1A and 1B illustrate packaging 100 including a container 102, such as a tube or a bottle, and a cap 104. The cap 104 is configured to couple with the container and prevent the contents of the container from spilling out or becoming contaminated. The cap 104 includes internal threads (not shown) configured to engage with external threads 106 disposed on a nozzle 108. The nozzle 108 further includes an opening 110 to allow contents of the container to be squeezed, pumped, poured, or otherwise extracted from the container for use.

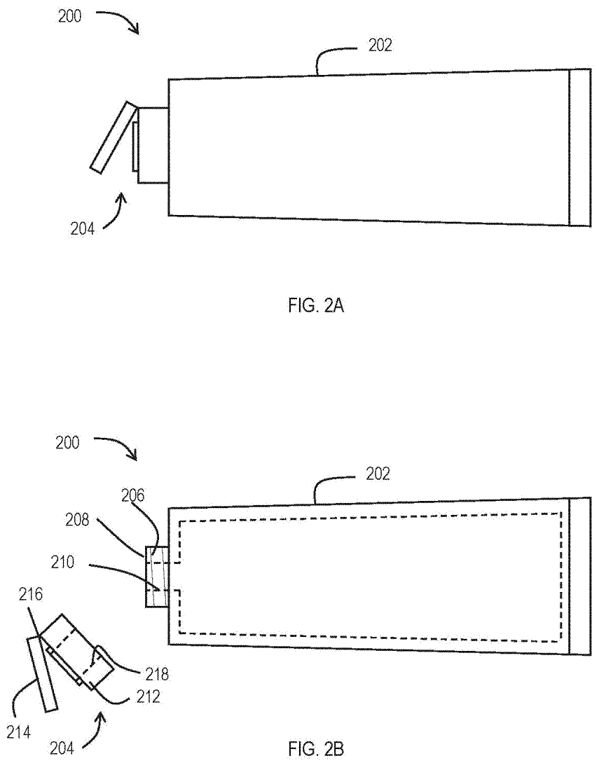

Looking to FIGS. 2A and 2B, another example of packaging 200 is shown having a different type of cap. Packaging 200 includes a container 202 and a cap 204 configured to close the container 202. FIG. 2B shows the cap 204 removed from a nozzle 208 on the container 202. The nozzle 208 may include external threads 206 configured to engage with internal threads (not shown) on the cap 204. The nozzle further includes an opening 210 through which the contents of the container may flow in response to the container being squeezed and/or inverted.

The cap 204 includes a cap body 212 which is configured to couple with the nozzle 208. The cap body 212 may include internal threads (not shown) that are configured to engage with the external threads 206. Alternatively, the body 212 may be coupled with the container using other coupling mechanisms such as press fitting, plastic welding, snap fitting, gluing, integrally forming, or other mechanical or chemical coupling mechanisms. The type of coupling for a particular packaging may depend in part upon the material of the container. In some embodiments, the container may be formed from polymer and/or metal materials such as low density polyethylene (LDPE), high density polyethylene (HDPE), ethyl vinyl alcohol copolymer (EVOH), aluminum, and layered laminates thereof may be used. The materials may be configured to be rigid, semi-rigid, or flexible and portions thereof may be elastically or plastically deformable.

The cap 204 further includes a cover 214 that may be completely separable from the body 212 or may be connected to the body 212 via a hinge 216 as shown. The hinge 216 is configured to selectively allow the cover 214 to swing away from an opening 218 in the body 212 so that contents of the container 202 may flow therethrough. The cover 214 may be pressed into contact with the body 212 to close the opening 218 and prevent contents of the container from spilling out. The cover 214 may be held securely in the closed position by a snap fit geometry or other detent or locking mechanism built into the cover 214 and/or the body 212.

FIGS. 1A-2B illustrate selected examples of containers and caps that may be used in toiletry, medical, food, and other packaging applications. In many applications, the contents of the packaging are intended to be used over a period of time and are not generally expended in a single use. For example, ointment, medication, toothpaste, lotion, soap, shampoo, condiments, cleaning supplies, hand sanitizer, therapeutics, drops, and other substances may be enclosed within a packaging that is intended to be used multiple times and, in some cases, by multiple different users. For example, a tube of toothpaste is commonly shared for weeks by more than one person in order to avoid having multiple tubes of toothpaste in a household. While this is an economical option and is environmentally more friendly than single-use packaging, multiple users sharing contents of a single package can facilitate the spread of germs between users. For instance, returning to the shared tube of toothpaste example, hundreds of millions of germs can exist on a single average toothbrush. When toothpaste is dispensed onto a toothbrush, germs from the toothbrush can be transferred to the nozzle or opening of the toothpaste tube and can then be transferred to the toothbrush of the next user dispensing toothpaste from the common tube. Similar germ transfer can occur from hands, wounds, kitchen utensils, etc. to various other types of packaging containing different substances. In some instances, germs can spread between people who share the contents of other types of single- or multi-use containers. For example, people who smoke vaporized tobacco or other substances using a common hookah or a waterpipe may transfer germs between the users. It is even possible to transmit tuberculosis between people sharing a hookah pipe. People who inhale other gases, such as oxygen or flavored oxygen for therapeutic or recreational purposes, from common containers may similarly transfer germs from one person to another. Thus, there exists a need to separate dispensing regions on packaging or other containers that may be shared between multiple users in order to reduce spread of germs and improve hygiene.

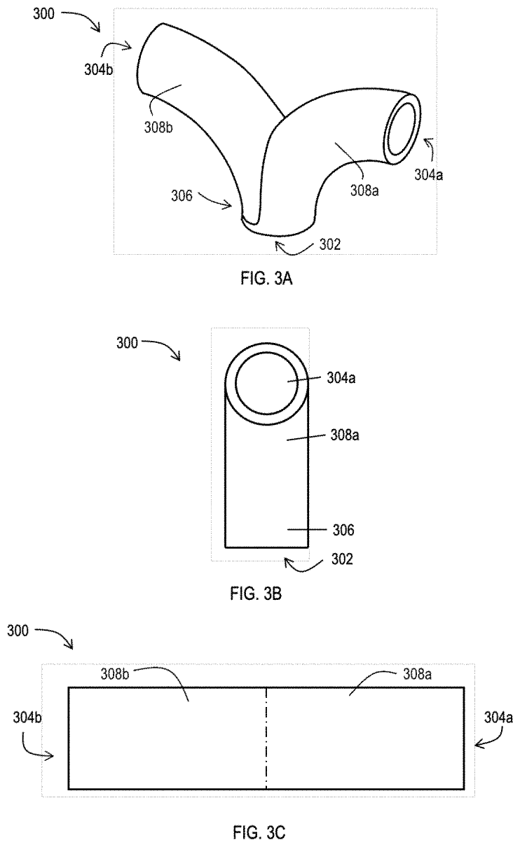

Referring to FIGS. 3A-3C, an embodiment of a dispenser attachment 300 is shown in isometric, side, and top views, respectively. The dispenser attachment 300 is configured to couple with a container (not shown) at a dispenser inlet 302 by threaded, snap fit, elastic, or any other mechanical or chemical (e.g., adhesive) coupling mechanisms. In some embodiments, the cap included with a product's packaging at purchase, such as the caps 104, 204 discussed above, may be removed from the container and replaced with the dispenser attachment 300. Alternatively, the dispenser attachment 300 may be included with the packaging at purchase of the product. For example, the dispenser attachment 300 may be integrally formed with the container such that the container and dispenser attachment are a single piece or, alternatively, the dispenser attachment 300 may be assembled with the container during production and/or manufacturing of the product such that the product is provided or sold to a user or customer with the dispenser attachment included in the packaging.

While many containers have standardized thread sizing, there may be variations. For example, one toothpaste brand may use a container having an outlet with a first outer diameter and/or thread pitch; a second toothpaste brand may use a container having an outlet with a second outer diameter and/or thread pitch. To accommodate for the different common sizes, a separate adapter insert may be included with or sold separately from the dispenser attachment. The adapter may be used to accommodate container outer diameters that are smaller than an internal diameter of the dispenser attachment. The adapter may be substantially tubular having an outer diameter and thread pitch configured to sealably engage internal threads of the dispenser attachment inlet. The adapter may further include internal threads configured to sealably engage external threads of the container outlet. While threads are described as an example herein, other mechanical coupling or sealing mechanisms may also be used without departing from the scope of the present application. For example, detents, friction fits, or other interlocking geometries may be used. Additionally, while the adapter described herein is configured to step down to accommodate a small size container outlet, other step-up or step-down adapters may be used to accommodate large, small, or same size container outlets.

The dispenser attachment 300 advantageously includes a plurality of outlets 304a, 304b, with each outlet configured to receive a cap (not shown) to prevent contents of the packaging from spilling, oozing, or dripping out. Caps may be coupled with the dispenser attachment 300 using threaded, snap fit, elastic, adhesive, integral formation, or other mechanical or chemical (e.g., adhesive) coupling mechanisms. Each of the plurality of outlets 304a, 304b can be used exclusively by each user of the common packaging item. For example, a first user may dispense contents of a common packaging container exclusively through outlet 304a while a second user may dispense contents of the common packaging container exclusively through outlet 304b to minimize spreading of germs and contamination. More than two outlets may be included on the dispenser attachment to accommodate use by more than two users.

The dispenser attachment 300 may include a common conduit 306 configured to receive a substance from a container through the dispenser inlet 302. The common conduit 306 may branch into a plurality of separate sub-conduits 308a, 308b, each of the sub-conduits 308a, 308b configured to route a portion of the substance from the common conduit 306 to one of the plurality of outlets 304a, 304b. For example, a first user dispensing substance from a container through the outlet 304a would ensure that a cap (not shown) on the outlet 304b is securely closed and would then open a cap (not shown) disposed on the outlet 304a. The container may then be squeezed or inverted causing the substance to enter the common conduit 306 of the dispenser attachment 300 through the dispenser inlet 302. A small portion of the substance may enter the sub-conduit 308b; however, the closed cap prevents the substance from exiting through the opening 304b. A majority, or substantially all, of the substance enters sub-conduit 308a and exits through the uncapped opening 304a for use by the first user. Once the first user is finished dispensing the substance, the opening 304a is closed and the common item is ready for use by the same or another user at a later time.

In some embodiments, the dispenser attachment 300 may not include a common conduit 306. Instead, substantially the full interior of the dispenser attachment 300 may be formed from separate sub-conduits. The sub-conduits may be distinguished by dividing baffles or by divergent pathways through which portions of the substance may be directed. Such embodiments will be discussed further herein below.

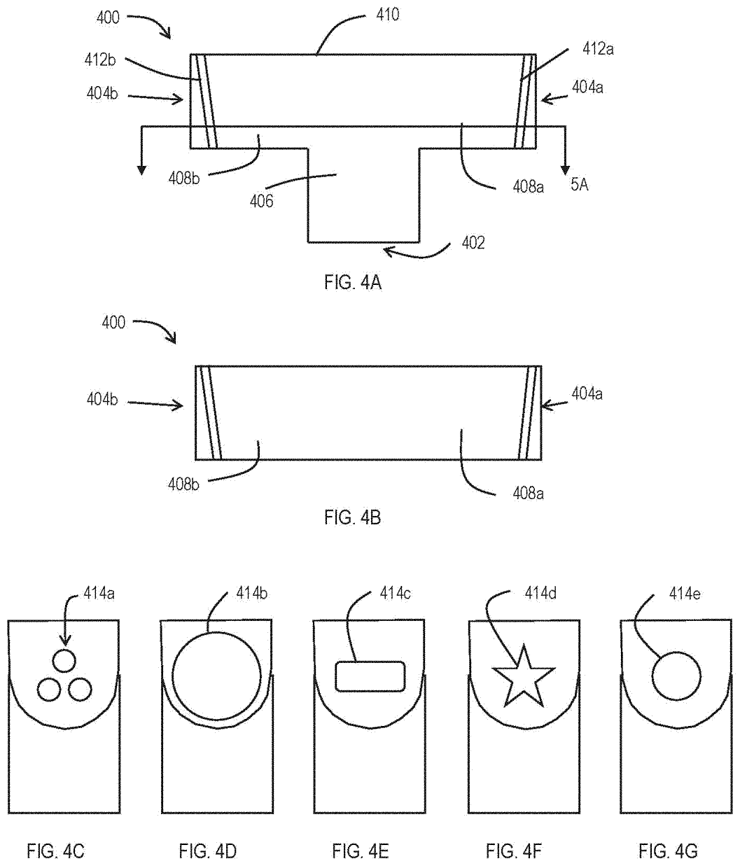

Referring to FIGS. 4A-4G, another embodiment of a dispenser attachment is illustrated. Similar to the dispenser attachment 300, the dispenser attachment 400 includes a dispenser inlet 402 and a plurality of outlets 404a, 404b. The dispenser inlet 402 is fluidly connected to the plurality of outlets 404a, 404b by a plurality of sub-conduits 408a, 408b, respectively. The dispenser attachment 400 includes a flat wall 410 on a side of the dispenser attachment 400 opposite the dispenser inlet 402. Such a flat wall 410 may allow for the dispenser attachment 400, and the attached container, to be set upside down on a surface. This may be particularly helpful for containers having viscous substances therein so that the substance is kept near the outlets 404a, 404b for easy dispensing. The dispenser attachment 400 is shown having external threads 412a, 412b near the outlets 404a, 404b for accepting threaded caps; however, as discussed above, other cap coupling mechanisms may be used.

Referring to FIGS. 4C-4G, examples of outlets having various shapes 414a-414e are shown. For example, outlet shape 414a includes a plurality of separate openings, shape 414b includes a single large circle, shape 414c includes an elongated ribbon, shape 414d includes a star, and shape 414e includes a small circle. Each outlet 404a, 404b may include the same or a different shape. In some embodiments, the two outlets 404a, 404b may have different shapes to help distinguish the two. For example, a first user may identify that he or she is using the correct outlet by confirming the shape of the outlet prior to dispensing substance through the outlet.

While outlet shape is one way to distinguish between a plurality of outlets, alternative or additional distinguishing features may be included on a dispenser attachment. For example, caps covering each outlet may have different colors, patterns, textures, or other features. In some embodiments, each of the sub-conduits may include different colors, patterns, textures, or other features. The various colors, patterns, and/or other distinguishing features may be customizable and may be applied to the dispenser attachment using known techniques. For instance, colors and patterns may be integrated into the material during a molding process or may be applied to the dispenser after fabrication using a transfer process such as screen printing.

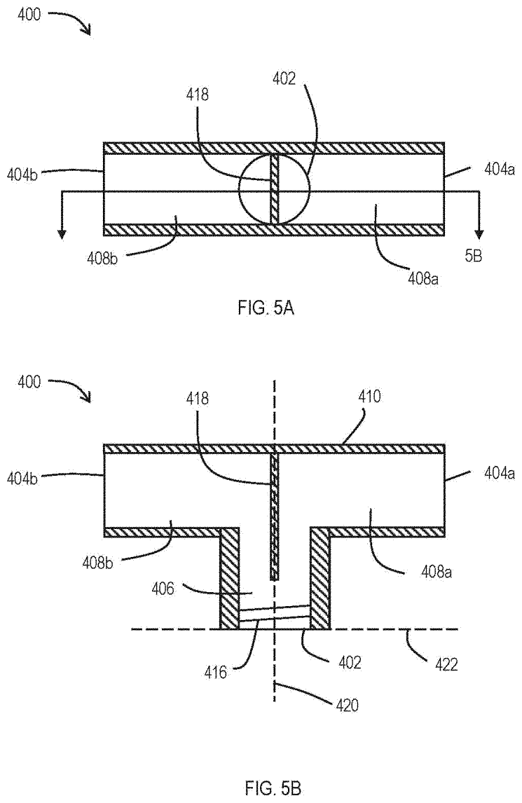

FIGS. 5A-5B show a top cross-sectional view and a side cross-sectional view of the dispenser attachment 400 described above. Referring to FIG. 5B, the dispenser attachment 400 is shown having dispenser inlet 402 with internal threads 416 configured to couple with external threads on a container. The diameter of the dispenser inlet 402 and the pitch of threads 416 may be selected to match an outlet or nozzle of a particular container. The dispenser attachment 400 includes a common conduit 406 into which a substance may flow from an attached container (not shown). The common conduit 406 leads to sub-conduits 408a, 408b which are at least partly separated by a dividing baffle 418. The dividing baffle 418 may extend along a first plane 420 that is substantially perpendicular to a second plane 422 on which the dispenser inlet 402 lies. While dividing baffle 418 is shown as a wall, the baffle may take other shapes in order to adjust shape of sub-conduits 408a, 408b and/or wall 410. The dividing baffle 418 may be a separate component assembled within the dispenser attachment 400 or may be integrally formed with the dispenser attachment 400 by, for example, molding or 3D printing fabrication processes.

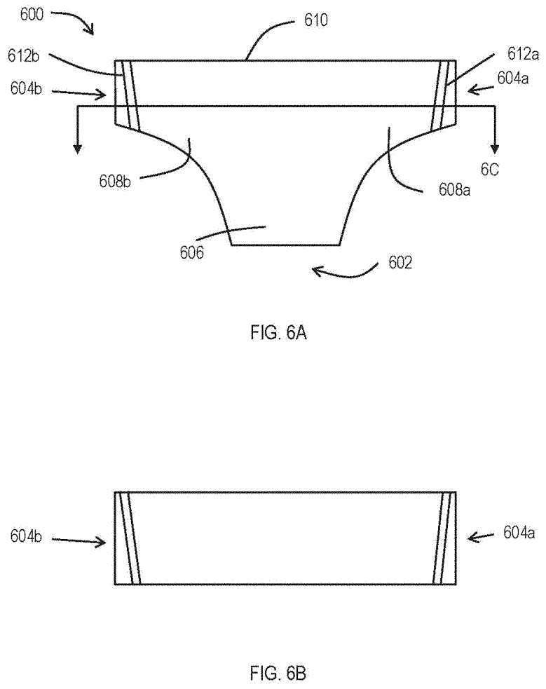

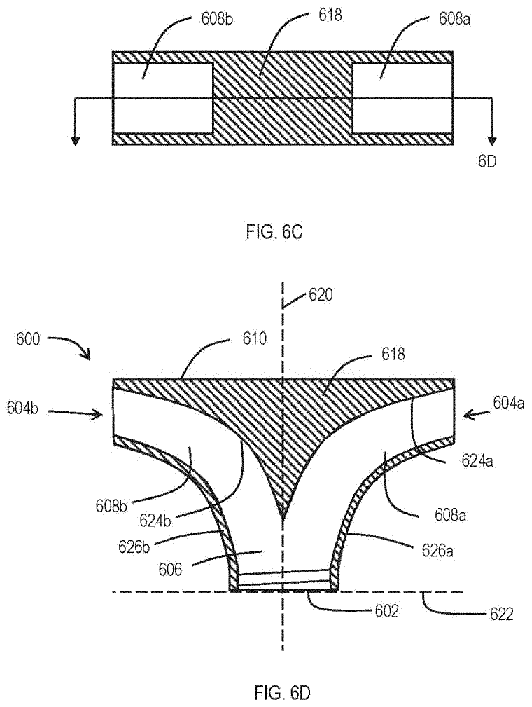

An example of an alternative baffle shape is shown in FIGS. 6A-6D. The dispenser attachment 600 includes a dispenser inlet 602 and a plurality of outlets 604a, 604b fluidly connected by common conduit 606 and a plurality of sub-conduits 608a, 608b. The sub-conduits 608a, 608b may be separated by a dividing baffle 618 between the plurality of sub-conduits. The dividing baffle 618 may have a cross section that decreases in size along a first axis 620 from a wall 610 toward the dispenser inlet 602. The axis 620 may be substantially perpendicular to a plane 622 on which the dispenser inlet 602 lies. The dividing baffle 618 may include one or more curved walls 624a, 624b to define at least a portion of the shape of sub-conduits 608a, 608b. In some embodiments, a similarly curved wall 626a, 626b may define another portion of the sub-conduits 608a, 608b so that the path of each sub-conduit includes a curved path free from sharp bends or corners in which the substance to be dispensed may collect. Optimizing the shape of sub-conduits 608a, 608b may allow for easier and more efficient dispensing of a substance therethrough. While the cross-section of the conduits 608a, 608b are shown as being substantially constant, the conduits 608a, 608b may vary in cross-sectional size and/or shape over its length. For example, an end of sub-conduit 608a near outlet 604a may have a smaller cross-section than an end of the sub-conduit 608a near the dispenser inlet 602. Other variations are possible without departing from the scope of the present disclosure.

In the dispenser attachment 600, openings 604a, 604b may lie on planes 626, 628, respectively. The planes 626, 628 may be angled with respect to the first plane 622. In some embodiments, the planes 626, 628 may be parallel with respect to each other. The planes 626, 628 may be substantially perpendicular to the first plane 622; however, other configurations are possible. For example, it may be advantageous to angle the opening slightly downward and toward or upward and away from the first plane 622 to direct a substance for easier dispensing. In some embodiments, an adjustable sub-conduit may be used so that the direction of the opening relative to the dispenser inlet may be adjusted by a user. For example, the sub-conduit may include a bellowed portion similar to a bendy straw.

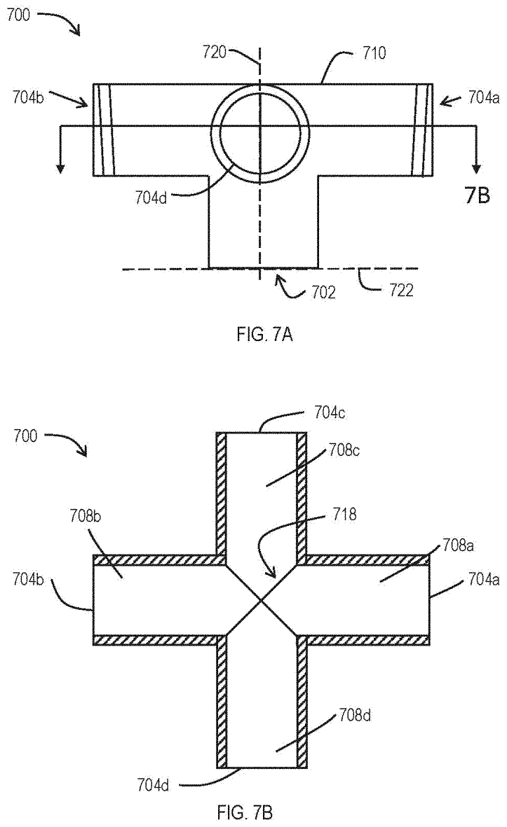

FIGS. 7A-7B show a side view and a side cross-sectional view of a dispenser attachment 700 in accordance with embodiments disclosed herein. The dispenser attachment 700 includes a dispenser inlet 702 configured to attach to a container. The dispenser attachment 700 includes a plurality of outlets 704a, 704b, 704c, and 704d. The outlets 704a-d are separated by a divider baffle 718. The divider baffle 718 may have an x-shaped cross section when viewed from a top cross-sectional view, as shown in FIG. 7B. Alternatively, the cross-sectional size and/or shape of divider baffle 718 may change from a wall 710 toward the dispenser inlet 702 along an axis 720 substantially perpendicular to a plane 722 on which the dispenser inlet 702 lies. In particular, the cross-sectional size may decrease from the wall 710 toward the dispenser inlet 702 along the axis 720. While four sub-conduits 708a-d and four outlets 704a-d are shown symmetrically arranged about the axis 720, more or fewer outlets and sub-conduits may be included and may be arranged symmetrically or asymmetrically about the axis 720.

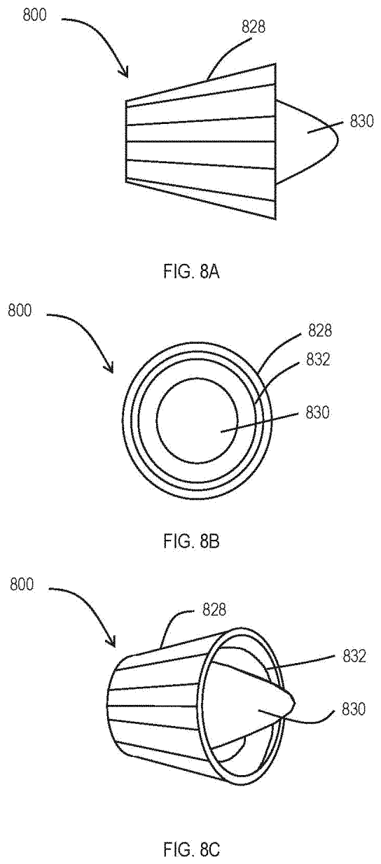

FIGS. 8A-8C illustrate an embodiment of a cap in accordance with the present disclosure. While traditional caps may be used in combination with any of the dispenser attachments discussed herein, the cap 800 may provide particular advantages. The cap 800 includes an outer surface 828 that may include ridges or other texture to improve gripping. The cap 800 further includes a protrusion 830 configured to insert into, for example, an opening on a container or an outlet on a dispenser attachment described herein. The protrusion 830 may serve to push substance back into the container or dispenser attachment so that the substance does not build up inside of the cap. As a result, more of the substance may be used and less of the substance is wasted. The cap 800 may include internal threads 832 configured to engage threads on a container or dispenser attachment so that a seal is created therebetween. While the protrusion 830 is shown having a rounded, tapered shape, other shapes and sizes are possible without departing from the scope of the present disclosure.

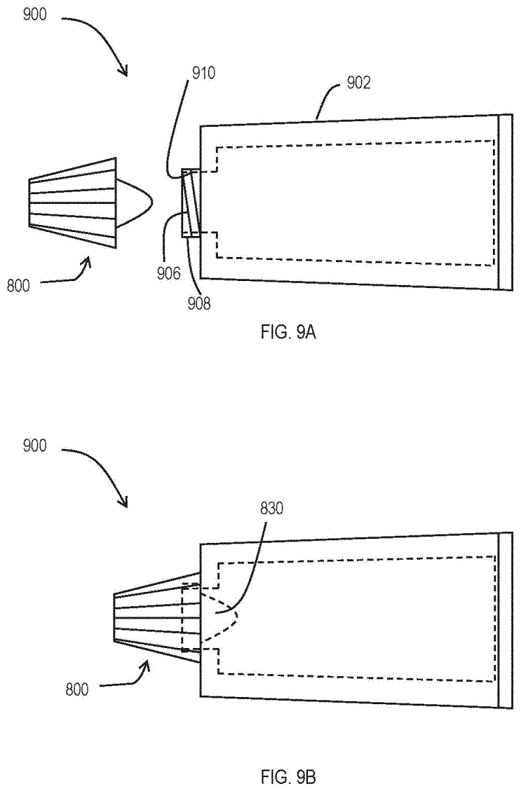

FIGS. 9A-9B show packaging 900 including a container 902 and the cap 800. The container 902 includes a nozzle 908 with external threads 906 thereon. The nozzle 908 includes an opening 910 configured to allow a substance within the container 902 to exit therethrough. The cap 800 includes internal threads configured to rotatably engage external threads 906 on nozzle 908, thereby sealing the opening 910 as shown in FIG. 9B. The protrusion 830 extends into the opening 910 to push a substance back into the container 902 and prevent a volume of the substance from collecting within the cap and becoming unusable.

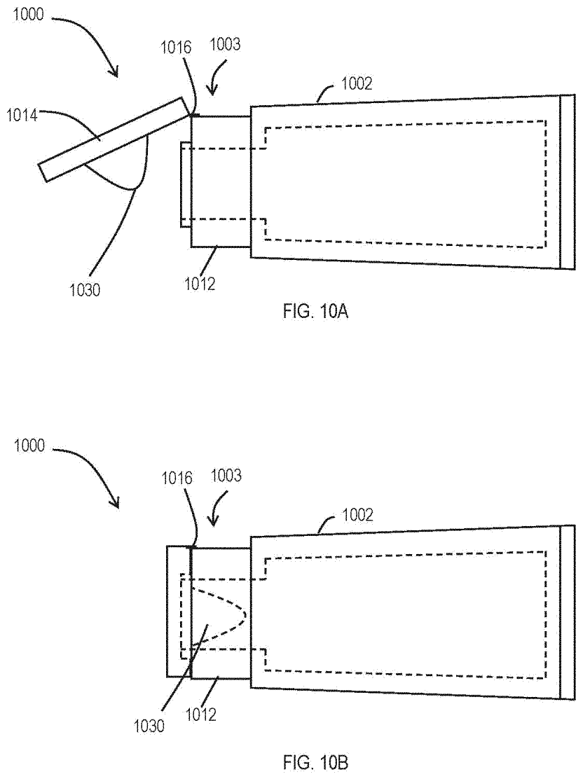

FIGS. 10A-10B show packaging 1000 including a container 1002 and a cap 1003. The cap 1003 includes a cap body 1012 having an opening therethrough. The cap body may further include threads or other attachment mechanism configured to sealably engage the container 1002. The cap 1003 includes a selectively removable cover 1014 configured to selectively open and close the opening in the cap 1003. The cap 1003 may include a hinge 1016 on which the cover 1014 can swing to open and close the opening. The cover 1014 includes a protrusion 1030 configured to insert into the opening of the cap body 1012 and/or the container 1002 when the cover 1014 is closed, as shown in FIG. 10B.

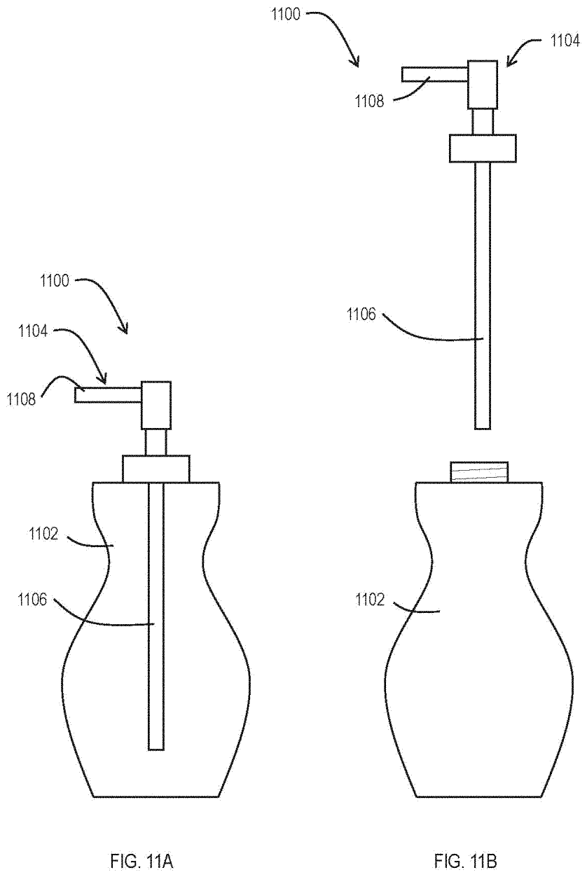

Referring to FIGS. 11A-11B, packaging 1100 is shown having a container 1102 and a pump 1104 having a straw 1106 and a dispenser 1108. As a user pushes the dispenser 1108 downward toward the container 1102, a substance within the container is drawn through the straw 1106 and out of an opening (not shown) in the dispenser 1108.

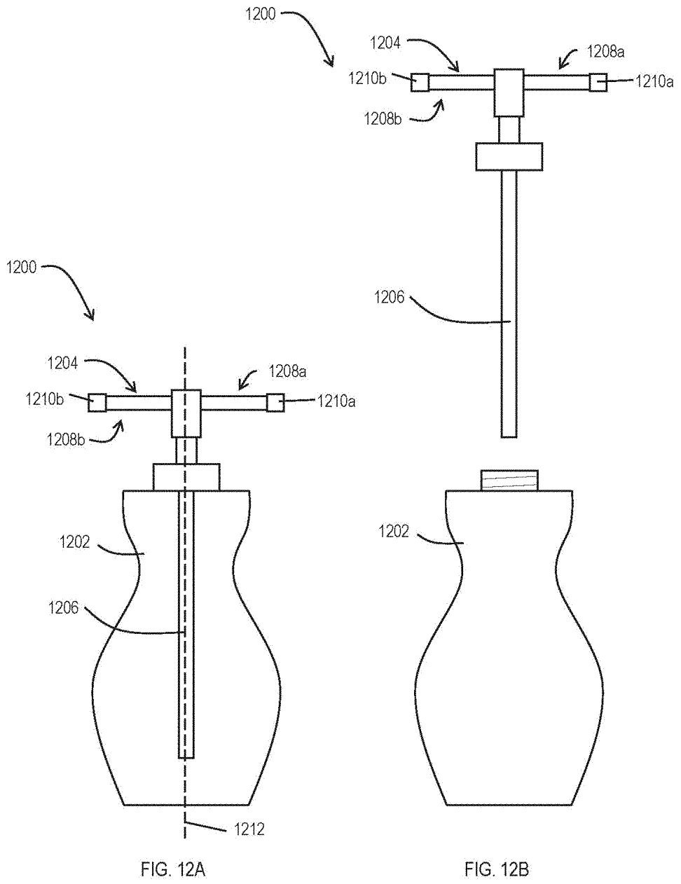

An alternate pump configuration is shown in FIGS. 12A-12B. Packaging 1200 includes a container 1202 and a pump 1204 having a straw 1206 and a plurality of dispensers 1208a, 1208b fluidly connected with the straw 1206. The pump 1204 may further include caps or plugs 1210a, 1210b configured to selectively close one or more openings in the dispensers 1208a, 1208b. Similar to embodiments discussed herein above, the pump 1204 which includes multiple dispensers 1208a, 1208b may help maintain hygiene and reduce spreading of germs between multiple people using a common packaging 1200. For example, a first user may exclusively use a first dispenser 1208a while a second user may exclusively use a second dispenser 1208b. To use the packaging 1200, a first user may remove a cap or plug 1210a and visually or physically confirm that the cap or plug 1210b is securely in place. The first user may then push the pump 1204 toward the container 1202 along the longitudinal axis 1212 to draw a substance therein through the straw 1206 and out through the first dispenser 1208a for use. The first user may then seal the first dispenser 1208a using the cap or plug 1210a so that the packaging 1200 is ready for subsequent use by a first or second user. While two dispensers 1208a, 1208b are shown, additional dispensers may also be included to accommodate additional users.

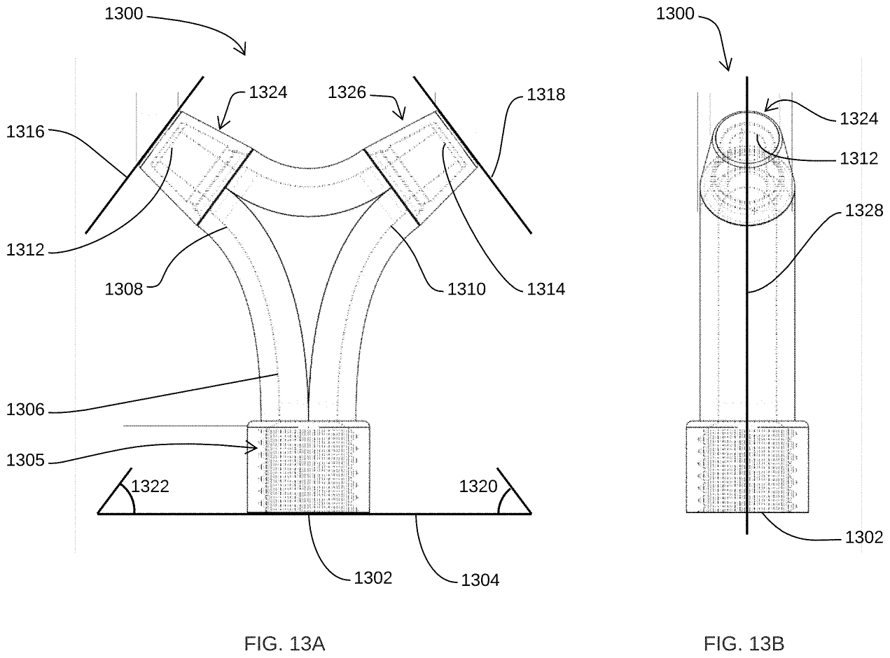

Referring to FIGS. 13A and 13B, a dispenser attachment 1300 is illustrated in front and side views, respectively. The dispenser attachment 1300 includes an inlet 1302 disposed on a plane (i.e., inlet plane 1304). In fluid communication with the inlet 1302 is a common conduit 1306 that includes an internal geometry 1305 configured to sealably engage a container (not shown). The internal geometry 1305 may include threads or any other shape or mechanism to allow a sealable connection to the container. The common conduit 1306 branches into two sub-conduits 1308, 1310. The first sub-conduit 1308 is in fluid communication with the common conduit 1306 and with a first outlet 1312. The second sub-conduit 1310 is in fluid communication with the common conduit 1306 and with a second outlet 1314. The first outlet 1312 is disposed on or parallel to a first outlet plane 1316 and the second outlet 1314 is disposed on or parallel to a second outlet plane 1318. A first angle 1320 between the inlet plane 1304 and the first outlet plane 1318 is between approximately 0 degrees and 90 degrees. In some embodiments, the first angle 1320 may be between approximately 40 degrees and 60 degrees or between approximately 50 degrees and 60 degrees. A second angle 1322 between the inlet plane 1304 and the second outlet plane 1318 is between approximately 0 and 90 degrees. In some embodiments, the second angle 1322 may be between approximately 40 degrees and 60 degrees or between approximately 50 degrees and 60 degrees. The first and second angles 1320, 1322 may be the same or different. First and second caps 1324, 1326 may be placed over the first and second outlets 1312, 1314, respectively, and may be removably engaged using geometry that includes mechanical locking, friction, detents, or other mechanisms.

The right side view of dispenser attachment 1300 illustrated in FIG. 13B shows the inlet 1302 and the first outlet 1312 underneath cap 1324. The inlet 1302 and the first outlet 1312 are centered along a frontal plane 1328 as shown. While not shown in FIG. 13B, the second outlet 1314 is also centered along the frontal plane 1328 in some embodiments.

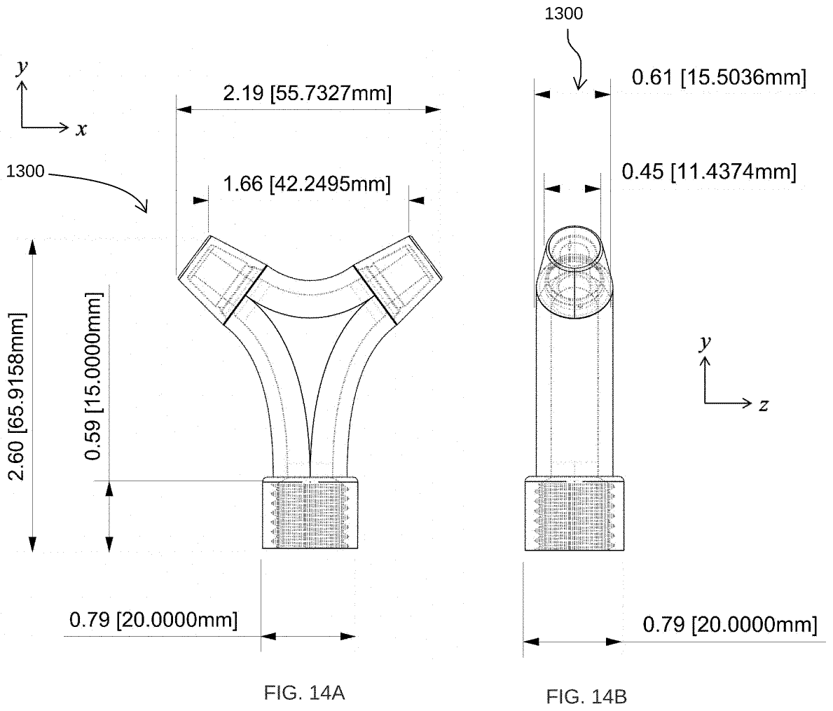

FIGS. 14A and 14B provide example dimensions of the dispenser attachment 1300 described with respect to FIGS. 13A and 13B. For example, the dispenser attachment 1300 may have a total height (e.g., in they-dimension) between approximately 2 and approximately 3 inches and, in some embodiments, the total height may be between approximately 2.5 and 2.75 inches. In some embodiments, the total height is approximately 2.6 inches. The total width (e.g., in the x-dimension) of the dispenser attachment may be between approximately 2 and 2.5 inches and, in some embodiments, the total width may between approximately 2 and 2.25 inches. In some embodiments, the total width may be approximately 2.19 inches. The total thickness of the dispenser attachment (e.g., in the z-direction) may be between approximately 0.5 and 1 inch and, in some embodiments, the thickness may be between approximately 0.75 inches and 1 inch. In some embodiments, the thickness may be approximately 0.79 inches.

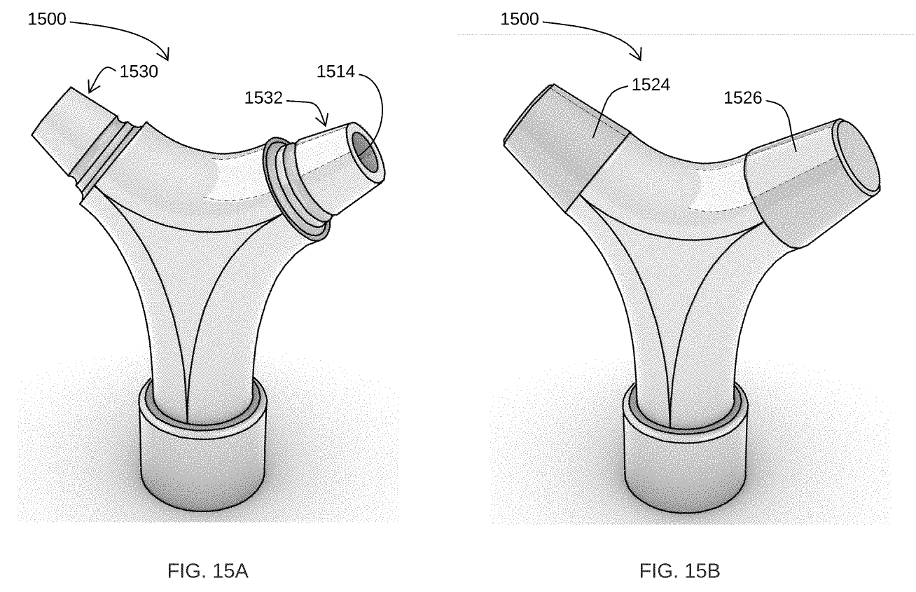

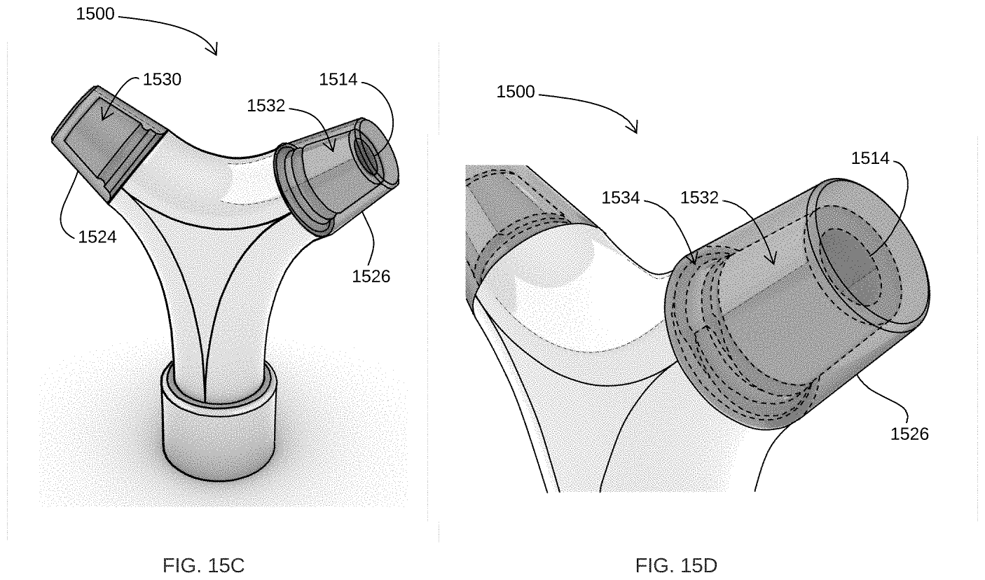

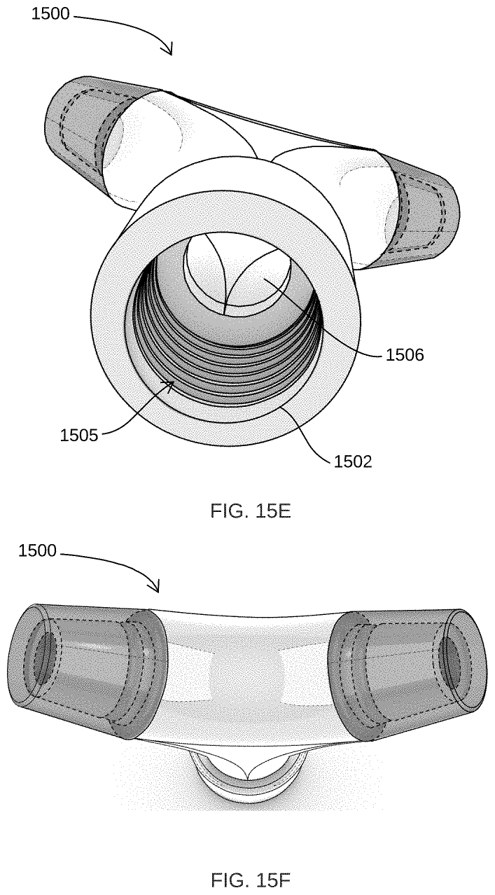

FIGS. 15A-15F show many different views of a dispenser attachment 1500. The dispenser attachment 1500 may be substantially similar in concept to the dispenser attachment 1300 described herein above. FIG. 15A illustrates a perspective view of the dispenser attachment 1500 with caps removed to show nozzles 1530, 1532, each of which includes an outlet (e.g., outlet 1514). While not specifically shown in the FIGS. 15A-15F, the dispenser attachment 1500 may include a baffle or divider to separate fluid that enters the dispenser attachment via an inlet. The dispenser attachment may have a baffle similar to that shown in FIGS. 5A-5B or 6C-6D, although other configurations are possible without departing from the scope of the present application. One or more baffles may prevent at least a portion of fluid from the inlet from mixing between a first sub-conduit and a second sub-conduit. In some embodiments, one or more baffles may completely divide an internal volume within the dispenser attachment such that two fluid pathways are formed that do not interconnect within the dispenser attachment. In other embodiments, the one or more baffles may divide only a portion of the internal volume such that there is a common conduit within the dispenser attachment.

FIGS. 15B-15D illustrate the dispenser attachment 1500 with caps 1524, 1526 sealably engaged to cover the nozzles 1530, 1532. FIGS. 15C and 15D shows the caps 1524, 1526 as being formed from a transparent material such that nozzles 1530, 1532 are visible therethrough. FIG. 15D shows a detailed view of geometry 1534 between the cap 1526 and nozzle 1532. The geometry 1534 may include detents, splines, bumps, threads or other mechanical means for removably engaging the cap with the body of the dispenser attachment 1500.

FIG. 15E illustrates a bottom perspective view of the dispenser attachment 1500. The inlet is illustrated in fluid communication with the common conduit 1506 and an inlet internal geometry 1505 is shown within the common conduit 1506 proximate the inlet 1502. In this embodiment, the inlet internal geometry includes a threaded section. FIG. 15F shows a top perspective view of the dispenser attachment 1500.

In an additional use case, a dispenser attachment may be used with containers that hold gasses. For example, dispenser attachments may be used with oxygen canisters, flavored oxygen canisters or tanks, hookahs, water pipes, or other apparatus from which people breath vapors or gases. The dispenser attachment may be coupled with a hose or stem to divide inhaled vapor or gas to a specific nozzle on the dispenser attachment. The dispenser attachment may have two, three, four, five or more nozzles such that each person breathing in vapor or gas uses a designated nozzle to prevent sharing and spread of germs. Each nozzle may include, for example, a one-way valve, a push/pull valve, or other type of valve to selectively control flow of the gas or vapor. The one-way valve may prevent back flow of gas, liquid, paste or other substances from returning into the common container once they have exited through the nozzle. In some embodiments, the dispenser attachment may replace the hose or stem connected to the common vapor or gas container. The dispenser may include long and flexible sub-conduits to facilitate ease of use.

While the embodiments disclosed herein may be configured to allow many users to have an exclusive access port to the substance in a common or shared packaging, there may be scenarios in which it is difficult to include enough access ports for each person. For example, hand sanitizer pumps are commonly placed at the entrances of stores, hospitals, schools, and workplaces so that visitors may clean their hands before entering the building. In such instances, hundreds or thousands of people may use the packaging and it may become difficult to integrate as many unique access ports into the packaging. Thus, one configuration of a dispenser attachment is a personal, removable attachment configured to quickly and easily seal against a common container at a first end and to transfer a substance from the common packaging to a user at a second end. Such a dispenser attachment may be a straw-like conduit where the first end has a size or shape configured to fit on an outlet of the common container. In some embodiments, the first end is flexible to accommodate a range of common container outlet sizes or shapes. The dispenser attachment may have a particular color, pattern, texture, or other personalized feature that makes the dispenser attachment unique and distinguishable from other dispenser attachments so as to prevent accidental mix up.

The various dispenser attachments, caps, pumps, containers, and packaging components described herein may be formed from plastic, metal, and/or combinations thereof. The materials may be rigid or elastically or plastically deformable in order to facilitate the desired movement or sealing of a substance within a container.

Unless the context clearly requires otherwise, throughout the description and the claims, the words “comprise,” “comprising,” “include,” “including,” “have” and “having” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” “infra,” “supra,” and words of similar import, when used in this application, shall refer to this application as a whole and not to any particular portions of this application. Where the context permits, words in the above Detailed Description using the singular or plural number may also include the plural or singular number, respectively. The word “or” in reference to a list of two or more items is an inclusive (rather than an exclusive) “or”, and “or” covers all of the following interpretations of the word: any of the items in the list, all of the items in the list, and any combination of one or more of the items in the list, and does not exclude other items being added to the list. In addition, the articles “a,” “an,” and “the” as used in this application and the appended claims are to be construed to mean “one or more” or “at least one” unless specified otherwise.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements, and/or states are in any way required for one or more embodiments or whether these features, elements, and/or states are included or are to be performed in any particular embodiment.

While certain embodiments have been described, these embodiments have been presented by way of example only and are not intended to limit the scope of the disclosure. Features of any one of the embodiments can be combined and/or substituted with features of any other one of the embodiments. Certain advantages of various embodiments have been described herein.

Embodiments have been described in connection with the accompanying drawings; however, the figures are not drawn to scale. Distances, angles, etc. are merely illustrative and do not necessarily bear an exact relationship to actual dimensions and layout of the devices illustrated.

In the present disclosure, there have been disclosed several embodiments of the invention and, although specific terms are employed, they are used in a generic and descriptive sense only and not for purposes of limitation. Although a few exemplary configurations have been described herein, those skilled in the art will appreciate that many modifications and variations are possible without materially departing from the novel teachings and advantages of concepts described herein. Accordingly, all such modifications are intended to be included within the scope of this disclosure.

The foregoing embodiments have been described at a level of detail to allow one of ordinary skill in the art to make and use the devices, systems, methods, etc. described herein. A wide variety of variation is possible and various described components, elements, and/or steps may be altered, added, removed, or rearranged. While certain embodiments have been explicitly described, other embodiments will become apparent to those of ordinary skill in the art based on the forgoing disclosure and the following aspects.

In a first aspect, a dispenser attachment comprises a dispenser inlet configured to couple with a container; and at least two outlets, each of the two outlets having a removable cover.

In a second aspect, the removable cover is disposed on a cap.

In a third aspect, the cap is integrally formed with the dispenser attachment.

In a fourth aspect, the cap is selectively removable.

In a fifth aspect, the cap comprises internal threads configured to couple with external threads on the dispenser attachment outlet.

In a sixth aspect, the cap comprises a hinge configured to swing the removable cover away from at least one outlet.

In a seventh aspect, the removable cover comprises a protrusion configured to insert into at least one of the two outlets.

In an eight aspect, the inlet is oriented on a first plane and a first outlet of the two outlets is oriented on a second plane substantially perpendicular to the first plane.

In a ninth aspect, the second outlet of the two outlets is oriented on a third plane substantially perpendicular to the first plane.

In a tenth aspect, the dispenser attachment further comprises a baffle extending along a fourth plane substantially perpendicular to the first plane.

In an 11^{th} aspect, the baffle is between the first and second outlets.

In a 12^{th} aspect, the inlet is disposed at a first side of the dispenser attachment and a second side of the dispenser attachment opposite the first side comprises a flat plane substantially parallel to the inlet.

In a 13^{th} aspect, at least one of the at least two outlets comprises a shape selected from a group consisting of a circle, an oval, a rectangle, a triangle, a star, and an elongated shape.

In a 14th aspect, each of the at least two outlets comprises the same shape.

In a 15^{th} aspect, each of the at least two outlets comprises a different shape.

In a 16^{th} aspect, the first outlet is a first color and the second outlet is a second color different from the first color.

In a 17^{th} aspect, a first removable cover is a different color from the second removable cover.

In an 18^{th} aspect, the dispenser attachment is formed from at least one material selected from a group consisting of polymer and metal.

In a 19^{th} aspect, the polymer material is a rigid polymer.

In a 20^{th} aspect, the dispenser attachment comprises at least a third outlet, the third outlet comprising a third removable cover.

In a 21^{st} aspect, the third outlet is disposed on a fifth plane substantially perpendicular to the first plane.

In a 22^{nd} aspect, the first, second, and third outlets are evenly spaced around a longitudinal axis of the conduit.

In a 23^{rd} aspect, the third outlet is a different color from the first and second outlets.

In a 24^{th} aspect, the third outlet comprises a different shape than the first and second outlets.

In a 25^{th} aspect, the dispenser attachment further comprises a pump between the inlet and the at least two outlets, wherein the pump is configured to allow the at least two outlets to move along a longitudinal axis of the conduit.

In a 26^{th} aspect, the pump is configured to transfer a product from the container toward at least one of the at least two outlets.

In a 27^{th} aspect, the inlet comprises internal threads configured to mechanically couple with external threads on the container.

In a 28^{th} aspect, the inlet comprises an elastic material configured to stretch over a portion of the container.

In a 29^{th} aspect, the dispenser attachment is integrally formed with the container.

In a 30^{th} aspect, the dispenser attachment comprises an adjustable sub-conduit.

In a 31^{st} aspect, the adjustable sub-conduit comprises adjustable bellows.

In a 32^{nd} aspect, the container is configured to store at least one selected from a group consisting of ointment, medication, toothpaste, lotion, soap, shampoo, condiments, cleaning supplies, hand sanitizer, therapeutics, and drops.

In a 33^{rd} aspect, a dispenser attachment comprises a dispenser inlet configured to removably couple with a container, and at least one outlet, wherein the dispenser attachment is configured to be coupled with the container before dispensing a substance therefrom and wherein the dispenser attachment is configured to be removed from the container after dispensing the substance therefrom.

In a 34^{th} aspect, a cap comprises a coupling mechanism configured to engage a container, and a protrusion configured to insert into an opening of the container when the coupling mechanism engages the container.

In a 35^{th} aspect, the protrusion is configured to push a substance into the container to prevent build up inside the cap.

In a 36^{th} aspect, the coupling mechanism comprises a threaded connection.

In a 37^{th} aspect, the cap comprises a body having an opening and a cover, wherein the protrusion is coupled with the cover, wherein the protrusion is configured to insert into the opening of the body, and wherein the cover is configured to move relative to the body by way of a hinge connecting the cover to the body.

What is claimed is:

1. A dispenser attachment comprising:
an inlet configured to couple with a container;
at least a first outlet and a second outlet, wherein the first outlet and the second outlet are in fluid communication with the inlet; and
at least a first cap and a second cap, wherein the first cap is configured to removably couple with the first outlet and the second cap is configured to removably couple with the second outlet.

2. The dispenser attachment of claim 1, wherein the first cap comprises a first removable cover that is selectively removable to expose the first outlet.

3. The dispenser attachment of claim 1, wherein the first cap comprises a first internal geometry configured to sealably engage a first external geometry disposed around the first outlet.

4. The dispenser attachment of claim 3, wherein the first internal geometry comprises a first internal thread and wherein the first external geometry comprises a first external thread.

5. The dispenser attachment of claim 1, further comprising:
a common conduit in fluid communication with the inlet;
a first sub-conduit in fluid communication with the common conduit and the first outlet; and
a second sub-conduit in fluid communication with the common conduit and the second outlet.

6. The dispenser attachment of claim 5, wherein the common conduit comprises an inlet internal geometry proximate the inlet.

7. The dispenser attachment of claim 6, wherein the inlet internal geometry comprises an inlet internal thread.

8. The dispenser attachment of claim 6, wherein the inlet internal geometry is configured to sealably couple with a container.

9. The dispenser attachment of claim 5, wherein the first sub-conduit is divided from the second sub-conduit by a baffle.

10. The dispenser attachment of claim 1, wherein the inlet is disposed on an inlet plane and the first outlet is disposed on a first outlet plane, and wherein a first angle between the inlet plane and the first outlet plane is between approximately 50 degrees and approximately 60 degrees.

11. The dispenser attachment of claim 10, wherein the second outlet is disposed on a second outlet plane, and wherein a second angle between the inlet plane and the second outlet plane is between approximately 50 degrees and approximately 60 degrees.

12. The dispenser attachment of claim 1, wherein the inlet and the first outlet are approximately bisected by a frontal plane.

13. The dispenser attachment of claim 12, wherein the second outlet is approximately bisected by the frontal plane.

14. The dispenser attachment of claim 1, wherein a height of the dispenser attachment is less than approximately 3 inches.

15. The dispenser attachment of claim 14, wherein the height of the dispenser attachment is greater than approximately 2 inches.

16. The dispenser attachment of claim 14, wherein a width of the dispenser attachment is less than approximately 2.5 inches.

17. The dispenser attachment of claim 16, wherein the width of the dispenser attachment is greater than approximately 2 inches.

18. The dispenser attachment of claim 16, wherein a thickness of the dispenser attachment is less than approximately 1 inch.

19. The dispenser attachment of claim 18, wherein the thickness of the dispenser attachment is greater than approximately 0.5 inches.

20. The dispenser attachment of claim 1, further comprising a first valve in fluid communication with the first outlet, wherein the valve is configured to selectively prevent a substance from passing through the first outlet.
